(19) United States
(12) Patent Application Publication
(10) Pub. No.: US 2026/0007127 A1
(43) Pub. Date: Jan. 8, 2026

(54) Pest Swatter Device with a Vacuum and Method of Use Thereof

(71) Applicant: Henry Charles Schmidt, III, Shiner, TX (US)

(72) Inventor: Henry Charles Schmidt, III, Shiner, TX (US)

(21) Appl. No.: 18/762,638

(22) Filed: Jul. 3, 2024

(51) Int. Cl. A01M 3/00; A01M 3/02

(52) U.S. Cl. CPC A01M 3/005; A01M 3/02; A01M 1/06

(57) ABSTRACT

An improved pest swatter device with a vacuum and method of use is described herein. The pest swatter device can comprise a swatter, a pest chamber, a housing, and a vacuum system. The swatter can comprise a planar head for swatting a pest and a tubular spine. The tubular spine can comprise a first end with a first orifice to receive the pest, and a second end with a second orifice to expel the pest. The pest chamber can connect to the second end of the tubular spine, configured to receive the pest. The housing can connect to the pet chamber. The vacuum system within the housing can create a vacuum sufficient to pull the pest through the tubular spine into the pest chamber. The method for using an improved pest swatter device can comprise the steps of swatting a pest and suctioning the pest through the pest swatter device.

### BACKGROUND

This disclosure relates to an improved pest swatter device with a vacuum and method of use thereof. Over the years, various methods have been developed to improve pest swatters. Most improvements have focused on the physical appearance or shape of the swatter. While these enhancements have been effective, they have not significantly improved the overall usability of the device. One well-known innovation in this field is the electric pest swatter. Such innovation can effectively kill any pest by delivering a high-voltage shock when the pest contacts the fly swatter's grid. Although effective in killing pests, it is known that through this method dead pests often get stuck on the grid, thus requiring periodic cleaning to maintain the device. Additionally, typical pest swatters and electric swatters do not address the issue of collecting dead pests. Usually after using the device, the user would still need to use a broom and a dustpan, or a vacuum to clean up afterwards, which can cause inconvenience and can be time-consuming for the user. Considering these issues, the integration of a suction mechanism with a fly swatter would improve the usability of the device by not only killing the pests but also efficiently collect their remains, thereby eliminating the need for additional cleaning tools and steps. One such device disclosed to the public has a suction device combined with a fly swatter. However, such device has the suction portion on the back end of the device, forcing the user to turn the device around and bend down to use the vacuum, while the soiled portion of the swatter would be turned toward the user. This is not optimal. As such it would be useful to have an improved pest swatter device with a vacuum and method of use thereof.

### SUMMARY

An improved pest swatter device with a vacuum and method of use is described herein. The pest swatter device can comprise a swatter, a pest chamber, a housing, and a vacuum system. The swatter can comprise a planar head for swatting a pest and a tubular spine. The tubular spine can comprise a first end with a first orifice to receive the pest, and a second end with a second orifice to expel the pest. The pest chamber can connect to the second end of the tubular spine. The pest chamber can be configured to receive the pest. The housing can connect to the pest chamber. The vacuum system can be within the housing. The vacuum system can create vacuum at the first orifice of the first end of the tubular spine. The vacuum can be sufficient to pull the pest through the tubular spine into the pest chamber.

In another embodiment, a method for using an improved pest swatter device with a vacuum can comprise the step of swatting a pest using the pest swatter device. The pest swatter device can comprise a swatter, a pest chamber, a housing, and a vacuum system. The swatter can comprise a planar head for swatting a pest and a tubular spine. The tubular spine can comprise a first end with a first orifice to receive the pest, and a second end with a second orifice to expel the pest. The pest chamber can connect to the second end of the tubular spine. The pest chamber can be configured to receive the pest. The housing can connect to the pest chamber. The vacuum system can be within the housing. The vacuum system can create vacuum at the first orifice of the first end of the tubular spine. The vacuum can be sufficient to pull the pest through the tubular spine into the pest chamber. The method can also comprise the step of suctioning the pest through the tubular spine of the pest swatter device.

### BRIEF DESCRIPTION OF THE DRAWINGS

FIG. 1 illustrates a pest swatter device comprising a swatter and a housing.

FIG. 2A illustrates an expanded view of a housing.

FIG. 2B illustrates a pest chamber removed from a housing.

FIG. 2C illustrates another embodiment of a pest chamber comprising a second opening.

FIG. 2D illustrates another embodiment of a pest chamber comprising a first opening and a second opening.

FIG. 3 illustrates a sectional view of a housing that mounts a vacuum system.

FIG. 4A illustrates a swatter detachable from a pest chamber.

FIG. 4B illustrates an expanded view embodiment of a quick-release fastener as a twist-lock system.

FIG. 5 illustrates a swatter and a housing as a single device.

FIG. 6A illustrates an embodiment of a tubular spine with a first end positioned at a top of a planar head.

FIG. 6B illustrates a back view embodiment of thereof.

FIG. 6C illustrates another embodiment of a tubular spine with a first end positioned at a base of a planar head.

FIG. 6D illustrates another embodiment of a tubular spine with a first end positioned within a planar head.

FIG. 7A illustrates an embodiment of a filter.

FIG. 7B illustrates another embodiment of a filter removed from a housing.

FIG. 8A illustrates a pest swatter device used to swat pests.

FIG. 8B illustrates a pest swatter device used to suction pests.

FIG. 8C illustrates how to dispose contents of a pest chamber.

### DETAILED DESCRIPTION

Described herein is an improved pest swatter with a vacuum and method of use thereof. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming but would nevertheless be a routine undertaking for those of ordinary skill in the field of the appropriate art having the benefit of this disclosure. Accordingly, the claims appended hereto are not intended to be limited by the disclosed embodiments but are to be accorded their widest scope consistent with the principles and features disclosed herein.

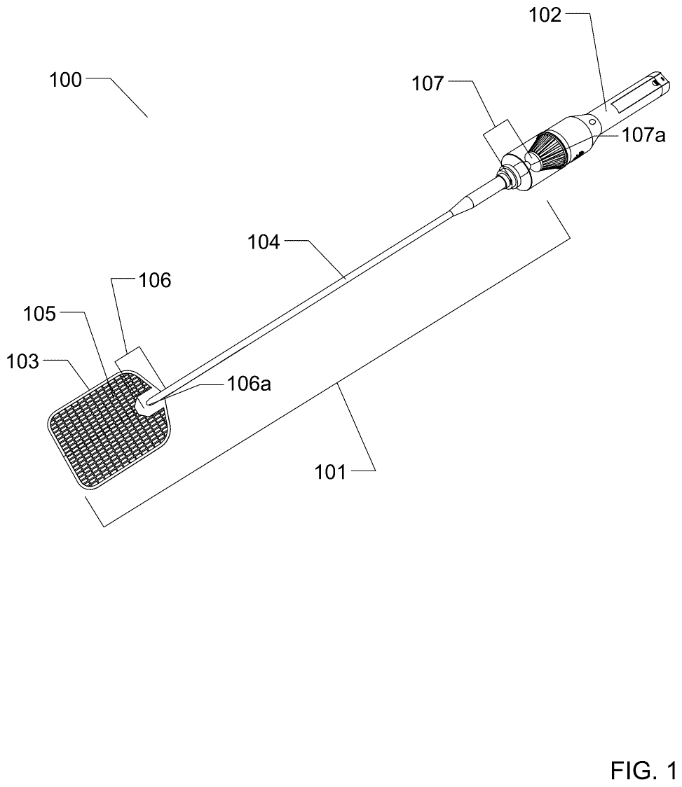

FIG. 1 illustrates a pest swatter device 100 comprising a swatter 101 and a housing 102. Swatter 101 can form at the top portion of pest swatter device 100 and is used for swatting pests while housing 102 can be at the bottom portion of the device and is used for suctioning the swatted pests. In one embodiment, swatter 101 can be attachable and detachable from housing 102 through various fastening methods, which can be further discussed below. Swatter 101 can comprise a planar head 103 and a tubular spine 104. Planar head 103 can come in various shapes and sizes, such as oval, square, circular, or rectangular. In a preferred embodiment, planar head 103 is flexible. Planar head 103 can comprise a grid 105 and can serve as the surface for swatting pests. Tubular spine 104 has a first end 106 with a first opening 106a to receive the pest and a second end 107 with a second opening 107a to expel the pest. As such, second opening 107 of tubular spine 104 can be connected to a portion of housing 102 wherein pests are expelled.

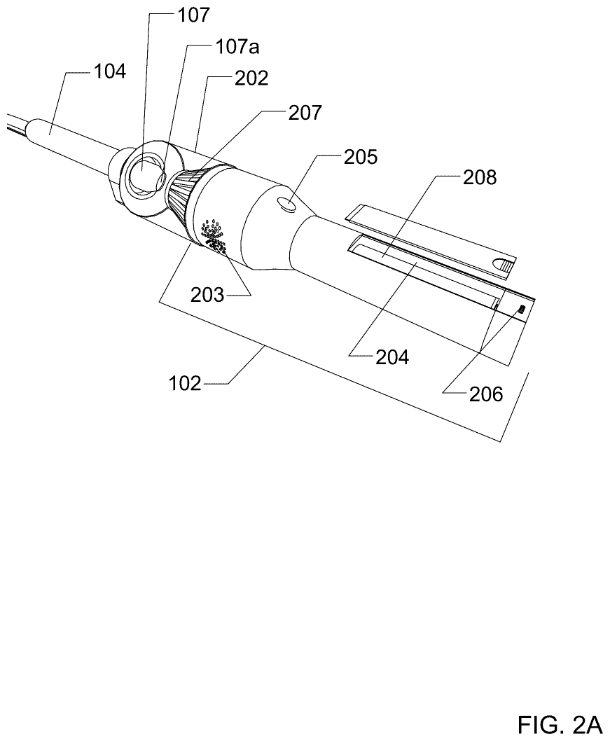

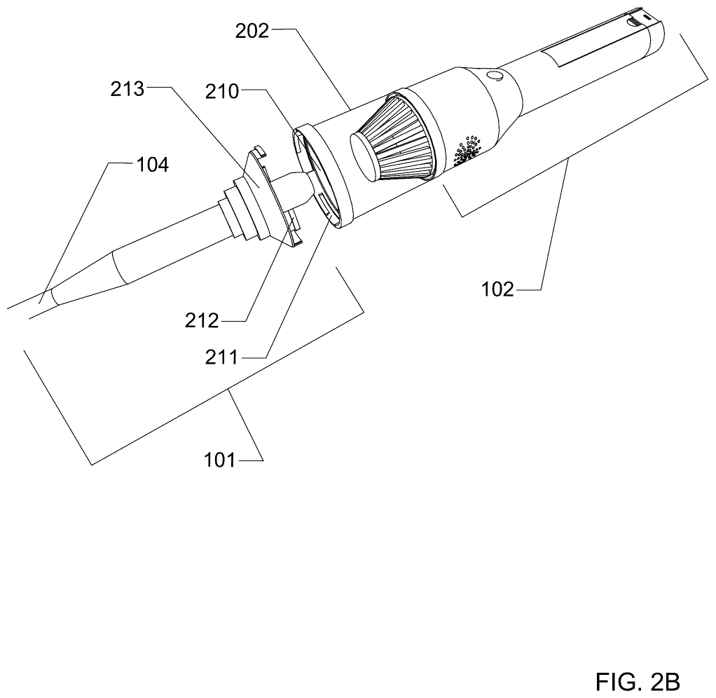

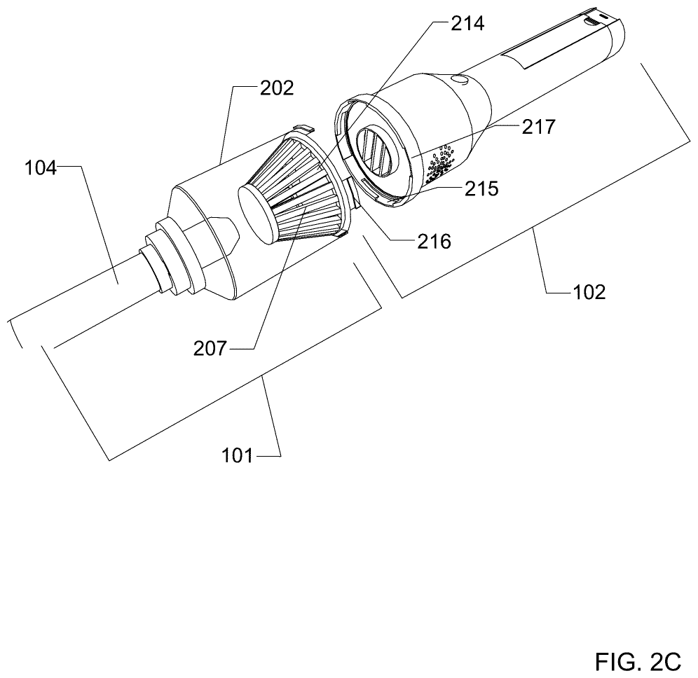

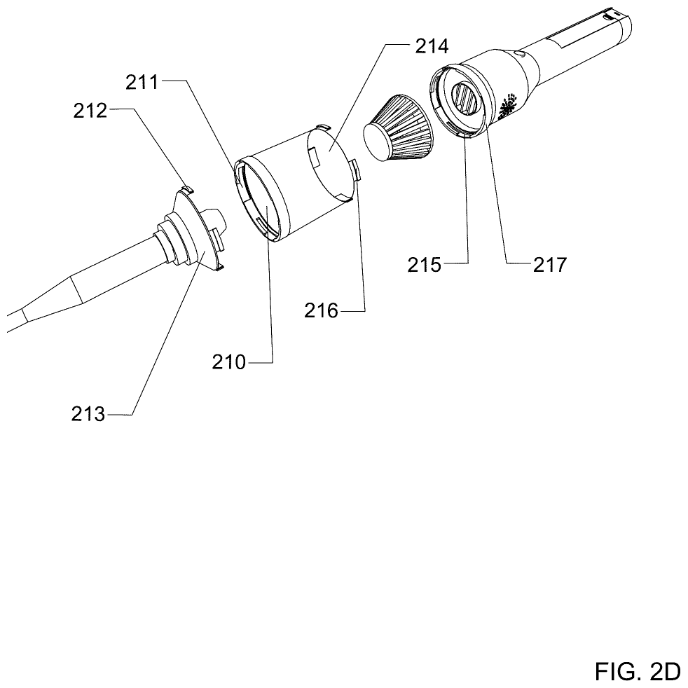

FIG. 2A illustrates an expanded view of housing 102. Housing 102 can securely hold parts of the vacuum system together. Furthermore, housing 102 can also function as a handle for pest swatter device 100. As such, housing 102 can provide a comfortable and secure grip to the user to allow the user to maneuver the device effectively. Housing 102 can also connect to a pest chamber 202 that is configured to receive the suctioned pests from tubular spine 104. In such structure, first end 106 of tubular spine 104 can be the portion of swatter 101 that comes in contact with surfaces when suctioning pests while second end 107 can be the portion of swatter 101 that is positioned within pest chamber 202. As such, tubular spine 104 can be configured to suction and direct swatted pests from first orifice 106a on planar head 103 into second orifice 107a that is within pest chamber 202. In a preferred embodiment, tubular spine 104 can extend partially into pest chamber 202. Such structure helps prevent pests from falling out of the tube when the device is manually manipulated. In one embodiment, tubular spine 104 can taper at the bottom end to prevent the collected dirt and pests from coming back out through the tubular spine. Further in one embodiment, tubular spine 104 can be removable from pest chamber 202. Further in one embodiment, pest chamber 202 can further comprise a filter 207. Filter 107 prevents pests from passing through chamber and into housing 102. In one embodiment, filter 107 can be built within a wall of housing 102 that faces pest chamber 202. In this embodiment, filter 107 can be permanently attached to housing 102. In other embodiments, filter 207 can be of various types, such as a HEPA filter, ULPA filter, and can be replaceable.

Furthermore, housing 102 can include an air vent 203, a battery compartment 204, a switch 205, and a charging port 206. Air vent 203 can be within a wall of housing 102 positioned below pest chamber 202. Furthermore, air vent 203 facilitates the airflow that goes through tubular spine 104 and pest chamber 202 into housing 102. Air vent 203 helps create the vacuum effect, which can draw the pests into and through tubular spine 104, and then into pest chamber 202. Switch 205 can be a push button momentary switch configured to control a vacuum system as described below. Housing 102 has compartment 204 to house a battery 208. In one embodiment the device can use a standard replaceable battery such as a double AA battery. In another embodiment, battery 208 can be a rechargeable battery such as Lead-Acid accumulator (Li—H battery). In such embodiment, housing 102 can comprise charging port 206 that can include but is not limited to micro-USB, USB-C, or a lightning port. Charging port 206 can be used to connect the device to an external power source to charge battery 208. In such embodiments, the housing can further comprise a battery indicator that can monitor the remaining battery charge of the device.

FIG. 2B illustrates swatter 101 detached from pest chamber 202. In one embodiment, pest chamber 202 can have a first opening 210. Further, in such embodiment, swatter 101 can be detachable from and attachable to pest chamber 202 using a connection system such as a twist lock. In such embodiment, pest chamber 202 can attach to a first set of tracks 211 and a first set of pins 212. Each track 211 can be an L-shaped guide mateable with each pin 212. Each pin 212 can be a protruding portion placed around the top rim ends of pest chamber 202 that locks pest chamber 202 in place. First opening 210 can be a hole on pest chamber 202 configured for the receiving and disposal of pests collected within pest chamber 202. In this embodiment, the bottom of swatter 101 can comprise a lid 213 that forms a wider circumference than tubular spine 104 such that lid 213 can be compatible with first opening 210. Lid 213 can completely seal first opening 210 of pest chamber 202. In this structure, pest chamber 202 can be accessible by twisting lid 213 which disengages lid 213 from first opening 210, exposing the contents of pest chamber 202. In this embodiment, filter 207 can be permanently attached to housing 102 using any methods known in the art, or filter 207 can be removable.

FIG. 2C illustrates another embodiment of pest chamber 202 comprising a second connection system. As illustrated the second connection system is also a twist lock mechanism at a second opening 214 of pest chamber 202. Second twist lock mechanism can include a second set of tracks 215 and a second set of pins 216.

In one embodiment, pest chamber 202 can only be accessible through second opening 214. As such, the top portion of pest chamber 202 can be permanently attached to the base of swatter 101 through methods that can include but is not limited to adhesion, cementing, or injection molding. In this embodiment, second set of pins 216 can be distributed around the base of pest chamber 202, while tracks 211 can be within a rim 217 on housing 102. This configuration can be reversed in one embodiment. Rim 217 can be a protruding edge on housing 102, positioned below pest chamber 202. Rim 217 can be configured such that the bottom of pest chamber 202 can be mounted within the edges of rim 217. Such structure can ensure that second opening 214 of pest chamber 202 can be completely sealed. In a scenario wherein filter 207 needs to be replaced, it can be more convenient to open pest chamber 202 through second opening 214.

FIG. 2D illustrates another embodiment of pest chamber 202 comprising first opening 210 and second opening 214. In this embodiment, pest chamber 202 can be accessible on both ends, first opening 210 and second opening 214.

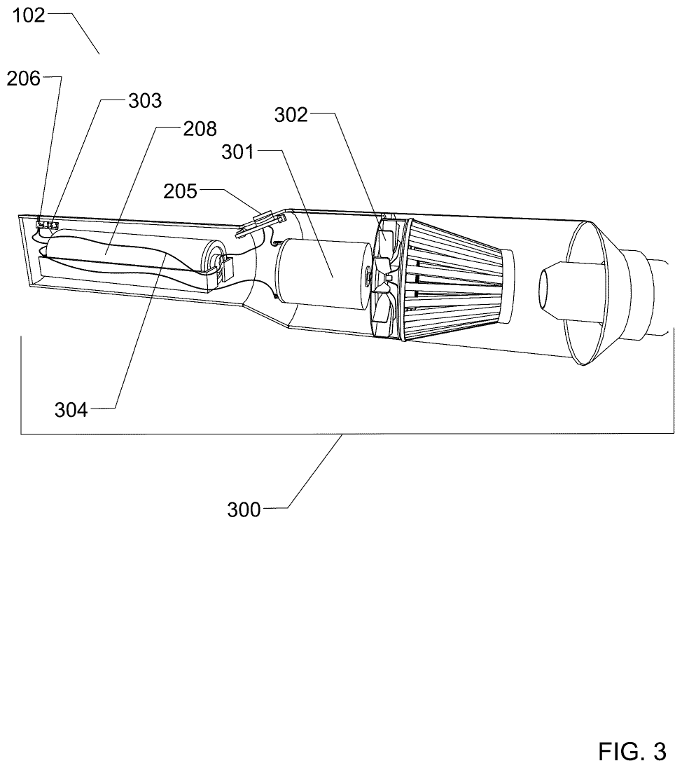

FIG. 3 illustrates a sectional view of housing 102 housing a vacuum system 300. In one embodiment, vacuum system 300 can comprise a motor 301, an impeller 302, battery 208, charging port 206, switch 205, and a charging controller 303 connected through a plurality of wires 304. Motor 301 connects to impeller 302, switch 205, battery 208, and charging controller 303 through wires 304. Turning on vacuum system 300 through switch 205 can then allow electrical energy to flow from battery 208 to charging controller 303. Charging controller 303 can then send a signal to motor 301 to operate. Once powered, motor 301 drives impeller 302 to rotate, creating a vacuum at first orifice 106a on the first end of tubular spine 104. The vacuum created pulls the pest through tubular spine 104 and out second orifice 107a of tubular spine 104, into pest chamber 202.

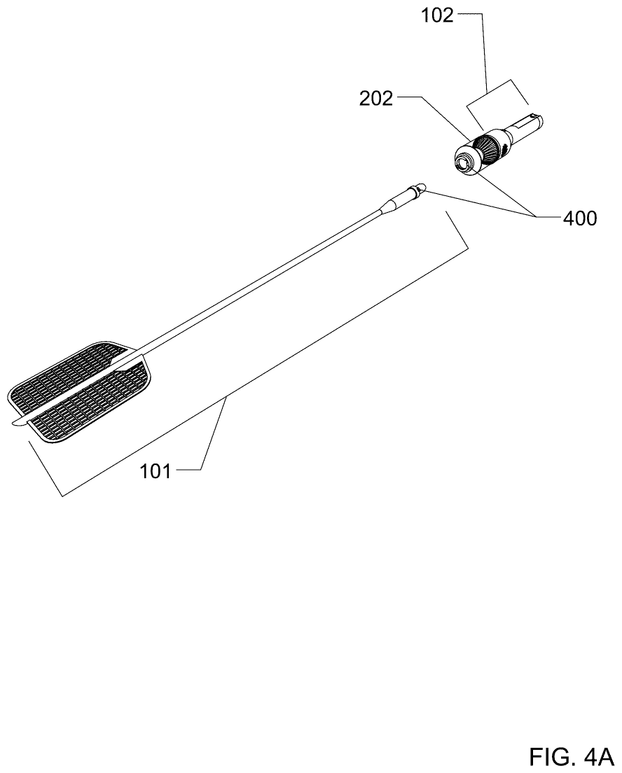

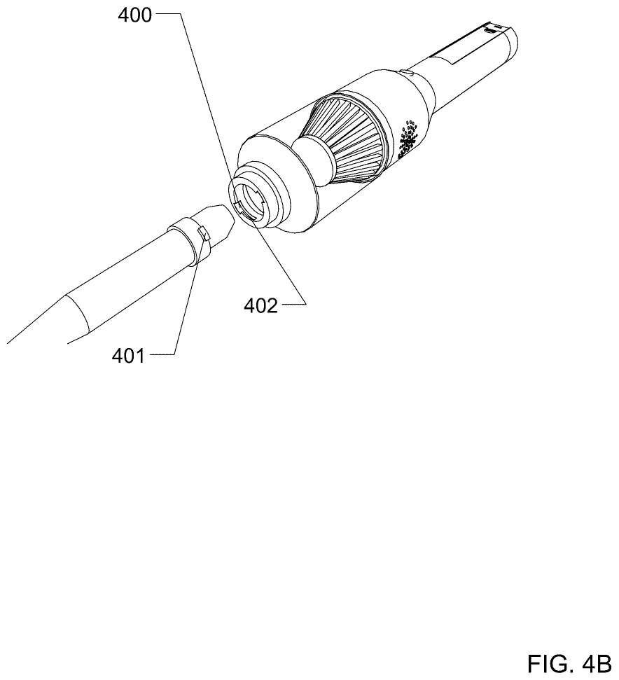

FIG. 4A illustrates swatter 101 detachable from pest chamber 202. In this embodiment, swatter 101 can be attached to pest chamber 202 using a connection system 400. For this disclosure, various types of connection systems 400 can be used to connect swatter 101 with pest chamber 202. Some examples of quick release fastening method can include but are not limited to snap-fit connectors, a twist-lock system, or a push-button release. In a preferred embodiment, connection system 400 is a twist-lock system. In such embodiment tubular spine 104 can be mateable with pest chamber 202 through twist-lock fasteners.

FIG. 4B illustrates an expanded view embodiment of connection system 400 as a twist lock system.

FIG. 5 illustrates one embodiment of an assembled pest swatter system. As assembled, planar head 103 can be used to strike a pest. The pest can then be pulled through tubular spine 104 into pest chamber 202 using the vacuum system within housing 102.

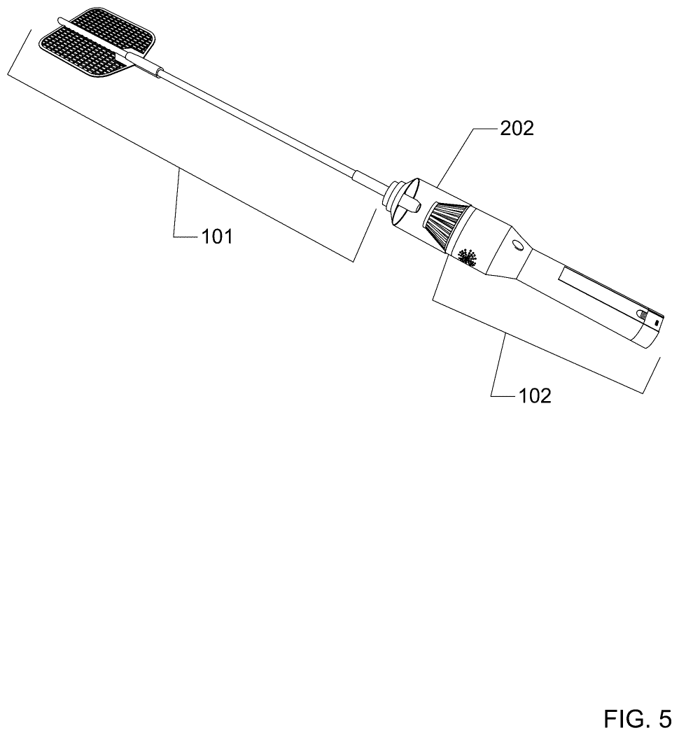

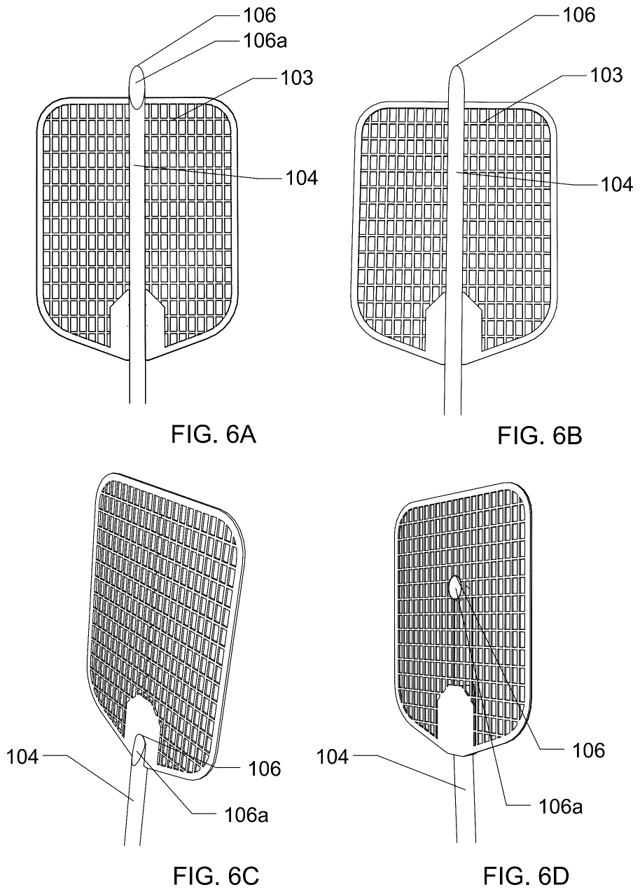

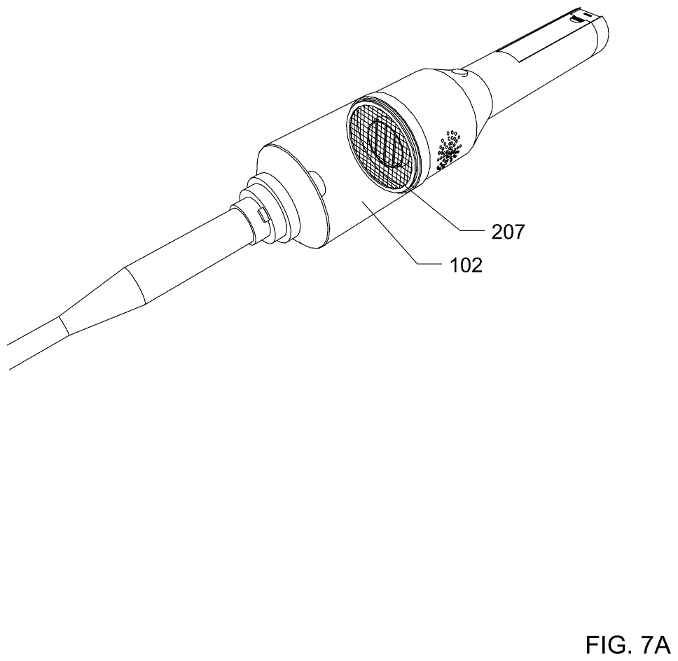

FIG. 6A illustrates an embodiment of tubular spine 104 with first end 106 positioned at a top of planar head 103. In this embodiment, first orifice 106a can be at a top of planar head 103. In one embodiment, first end 106 can form an angled nozzle tip. In this structure, tubular spine 104 can extend slightly beyond planar head 103 and the angled nozzle tip of first orifice 106a can be facing the front side surface of planar head 103. In one embodiment, tubular spine 104 can be flexible, which can allow the tubular spine to reach into corners, crevices and other hard-to-reach areas where swatted pests may have landed.

FIG. 6B illustrates a back view embodiment of tubular spine 104 positioned at a top of planar head 103.

FIG. 6C illustrates another embodiment tubular spine 104 with first end 106 positioned at a base of planar head 103. In this embodiment, tubular spine 104 does not protrude from planar head 103. Such structure retains the typical structure of a swatter device and provides a better weight distribution, resulting in improved maneuverability during operation, and allowing the user to accurately swat moving pests. Additionally, this design removes obstruction from planar head 103, providing a clearer line of sight when aiming at pests. Furthermore, this structure helps prevent the tubular spine 104 from bending and reduces the risk of fast wear and tear.

FIG. 6D illustrates another embodiment tubular spine 104 with first end 106 positioned within planar head 103.

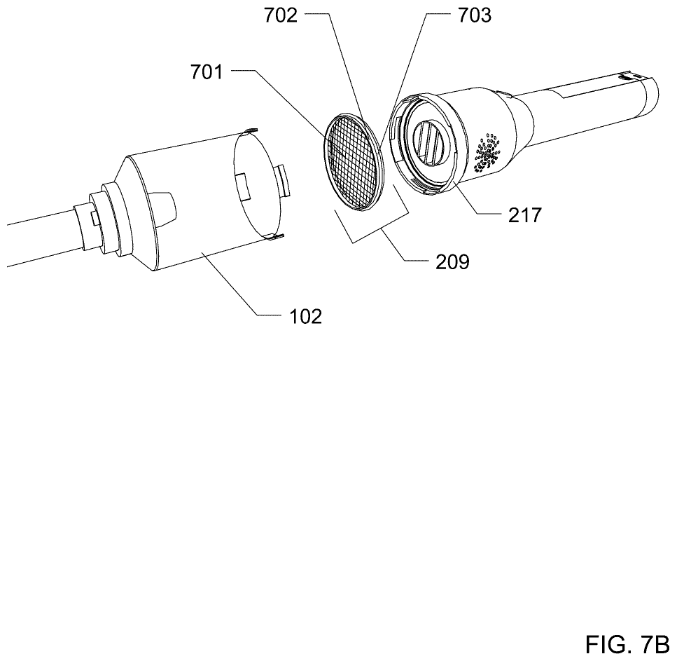

FIG. 7A illustrates a ring embodiment of filter 207. In this embodiment, filter 207 can be built within the wall of housing 102. In this embodiment, filter 207 can be substantially flat providing a compact design allowing the device to be more lightweight and smaller. In one embodiment, filter 207 can be a mesh filter. In another embodiment filter 207 can be a screen filter.

FIG. 7B illustrates another embodiment of filter 207 removed from housing 102. In this embodiment, filter 207 can further comprise a catch 701 and a ring 702. Catch 701 can be made of different filter materials that can include but is not limited to cloth filter, micron filter, fine dust filter, HEPA filter, etc. Catch 701 can be a substantially flat filter that prevents tiny particles and pests from being suctioned into vacuum system 300. Ring 702 can be made of rigid, durable material that forms the circular structure of catch 701. In this embodiment, filter 207 can fit snugly within rim 217. In one embodiment, the outer edge of ring 702 can further comprise a rubber 703 to ensure that filter 217 remains securely in place.

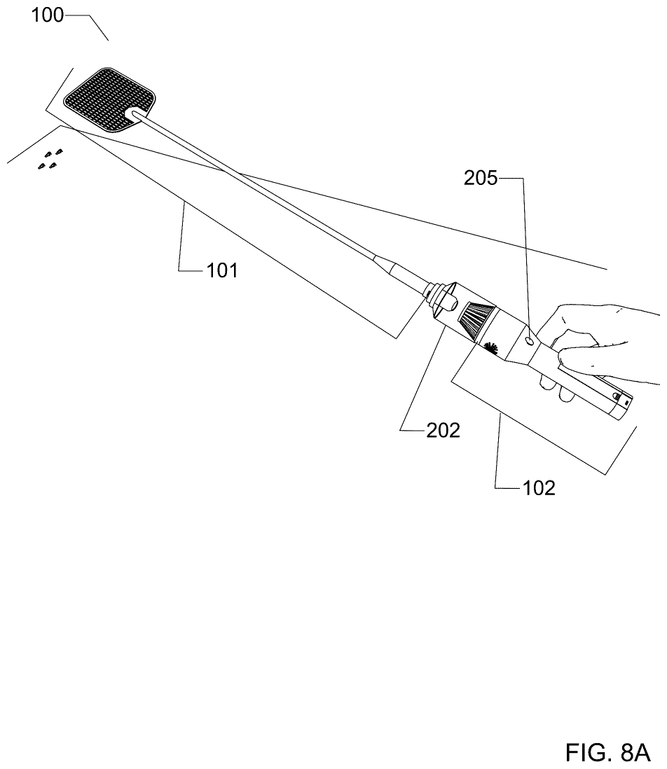

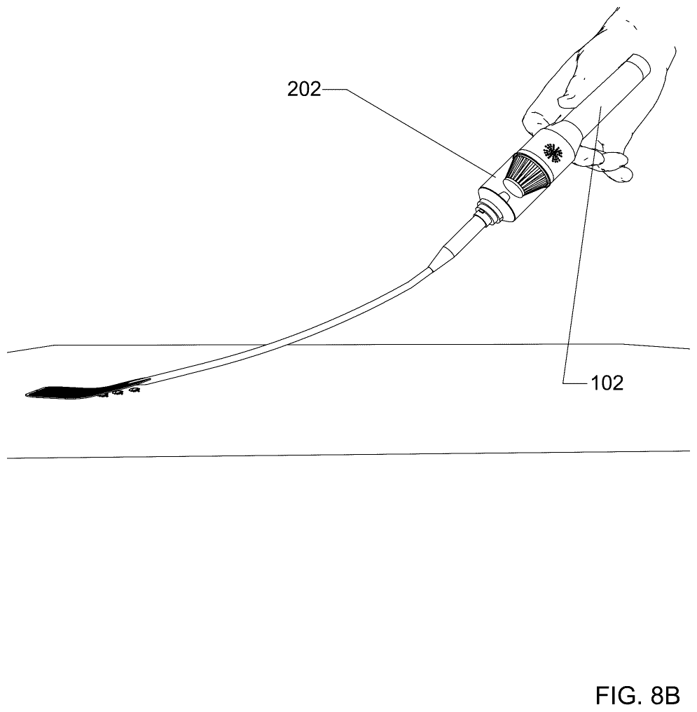

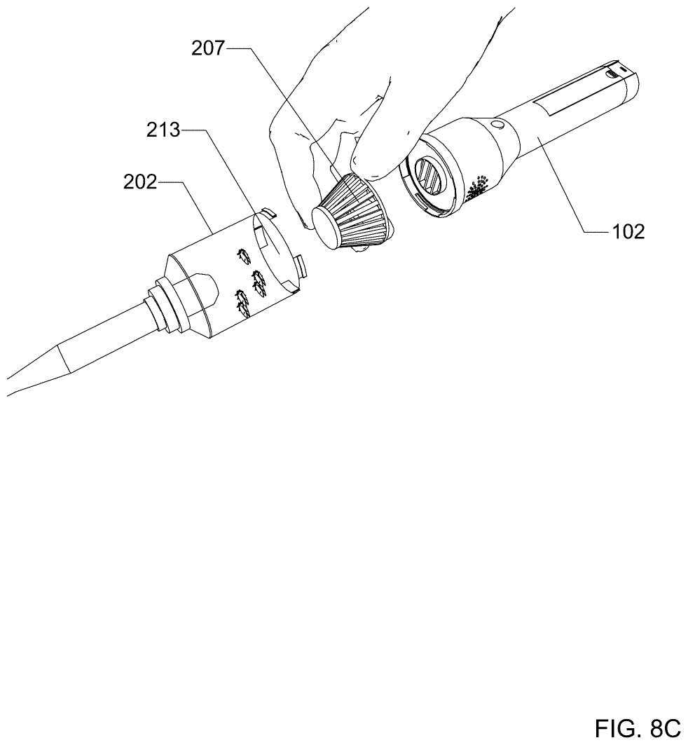

FIG. 8A illustrates a pest swatter device 100 used to swat pests. Initially, the user can start using swatter device 100 to swat pests. In an embodiment wherein swatter 101 and housing 102 can be separate devices, the user would first attach swatter 101 to pest chamber 202. After the pests are hit with the device, the user can actuate switch 205 to turn on motor 301 of the device. Once turned on, vacuum system 300 can start to operate and can be used to suction the swatted pests.

FIG. 8B illustrates swatter device 100 being used to suction pests. After swatting and turning the device on, the user can start using the device to collect the pests from any surface through tubular spine 104. Additionally, the angled nozzle tip of first end 106 can allow user to position planar head 103 as close to the surface as possible, enabling first orifice 106 to suction swatted pests even from gaps or small crevices in the surface. Next, pest and small particles can be suctioned through tubular spine 104 then directed and collected within pest chamber 202. The air that cycles out from air vent 203 can then be filtered through filter 207. After using the device, the user can actuate the switch again to turn the device off.

FIG. 8C illustrates how to dispose contents of pest chamber 202. After usage, the particles and pest collected within pest chamber 202 can be disposed by twisting pest chamber 202 to disengage the pest chamber from the device. Once twisted, pest chamber 202 disengages and is removed from housing 102. In one embodiment, pest chamber 202 can be opened at the top through first opening 210. In this embodiment, the collected pests can be disposed through the top portion of pest chamber 202. In another embodiment, pest chamber 202 can be accessed through the bottom portion of the chamber through second opening 214. In this embodiment, the user can first remove filter 207 that covers second opening 214 to dispose the swatted pests collected within the pest chamber. After disposing of the litter, pest chamber 202 can be reattached to housing 102 through twisting pest chamber 202 back in place.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A pest swatter device comprising
a swatter comprising
a planar head for swatting a pest and
a tubular spine, said tubular spine comprising
a first end with a first orifice to receive the pest and
a second end with a second orifice to expel the pest;
a pest chamber that connects to said second end of said tubular spine, said pest chamber configured to receive the pest, said second end of said tubular spine extending into said pest chamber;
a housing that connects to said pest chamber; and
a vacuum system within said housing that creates a vacuum at said first orifice of said first end of said tubular spine, said vacuum sufficient to pull said pest through said tubular spine into said pest chamber.

2. The pest swatter device of claim 1 wherein said swatter removably connects to said pest chamber.

3. (canceled)

4. The pest swatter device of claim 1 wherein said pest chamber removably connects to said housing.

5. The pest swatter device of claim 4 wherein said pest chamber removably connects to said housing using a twist-lock system.

6. The pest swatter device of claim 1 wherein said pest swatter device further comprises a filter within said pest chamber.

7. The pest swatter device of claim 6 wherein said filter is a mesh filter.

8. The pest swatter device of claim 6 wherein said filter is a screen filter.

9. The pest swatter device of claim 1 wherein said housing comprises a filter built within a wall of said housing.

10. The pest swatter device of claim 1 wherein said first orifice of said tubular spine is positioned at a base of said planar head.

11. The pest swatter device of claim 1 wherein said first orifice of said tubular spine is positioned within said planar head.

12. The pest swatter device of claim 1 wherein said first orifice of said tubular spine is positioned at a top of said planar head.

13. The pest swatter device of claim 1 wherein said tubular spine is flexible.

14. The pest swatter device of claim 1 wherein said vacuum system comprises
a motor;
an impeller; and
a battery that powers said motor to turn said impeller, and
a switch that connects and disconnects power from said battery to said motor.

15. A method for using a pest swatter device comprising the steps of swatting a pest using a pest swatter device, wherein said pest swatter device comprises
a swatter comprising
a planar head for swatting a pest and
a tubular spine, said tubular spine comprising
a first end with a first orifice to receive the pest and
a second end with a second orifice to expel the pest;
a pest chamber that connects to said second end of said tubular spine, said pest chamber configured to receive the pest, said second end of said tubular spine extending into said pest chamber;
a housing that connects to said pest chamber; and
a vacuum system within said housing that creates a vacuum at said first orifice of said first end of said tubular spine, said vacuum sufficient to pull said pest through said tubular spine into said pest chamber; and
suctioning the pest through said tubular spine of said pest swatter device.

16. The method of claim 15 wherein said vacuum system comprises
a motor;
an impeller; and
a battery that powers said motor to turn said impeller, and
a switch that connects and disconnects power from said battery to said motor.

17. The method of claim 16 further comprising the step of actuating said switch to power said motor.

18. The method of claim 15 further comprising a filter within said pest chamber.

19. The method of claim 18 further comprising the step of filtering the air that goes through said tubular spine and said vacuum system through said filter.

20. The method of claim 18 further comprising the step of removing said filter from said pest chamber prior to disposing the pests from said insect chamber.

21. The system of claim 1 wherein the second end of said tubular spine within said pest chamber is taperered.
